(19) United States
(12) Patent Application Publication
(10) Pub. No.: US 2010/0045830 A1
(43) Pub. Date: Feb. 25, 2010

(54) IMAGE CAPTURING DEVICE, SMEAR REDUCTION METHOD, AND COMPUTER READABLE STORAGE MEDIUM

(75) Inventor: Masami YUYAMA, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co. Ltd., Tokyo (JP)

(21) Appl. No.: 12/539,828

(22) Filed: Aug. 12, 2009

(30) Foreign Application Priority Data
Aug. 19, 2008 (JP) 2008-210786

(51) Int. Cl. H04N 9/64; H04N 5/335

(52) U.S. Cl. 348/249; 348/311; 348/E09.042; 348/E05.091

(57) ABSTRACT

An image capturing device employing an image sensor including a light receiving element and a transfer path for transferring charge obtained by exposing the light receiving element to light, comprises: a control unit for causing the image sensor to output an image signal the image signal including charge accumulated at the transfer path as a result of the photoelectric effect of the transfer path and not including charge accumulated at the light receiving element of the image sensor: and an output unit that subtracts the image signal outputted by the image sensor from an image signal including charge accumulated at the light receiving element of the image sensor and charge accumulated at the transfer path as the result of the photoelectric effect of the transfer path, and outputs a moving image using an image signal for after subtraction.

### CROSS-REFERENCE TO RELATED APPLICATIONS

This application is based on and claims the benefit of priority of the prior Japanese Patent Application No. 2008-210786, filed on Aug. 19, 2008, and including specification, claims, drawings and summary, the entire contents of which are incorporated herein by reference.

### BACKGROUND OF THE INVENTION

1. Field of the Invention

The present invention relates to an image capturing device, a smear reduction method, and a computer readable storage medium that are suitable for smear reduction.

2. Description of the Related Art

The use of Charge-Coupled Devices (CCDs) in image sensors is prevalent for digital method image capturing devices. Complementary Metal Oxide Semiconductor (CMOS) sensors have also become main stream as image sensors. However, since moving images are distorted as they are captured by such sensors, it has been preferable to adopt CCDs in image capturing devices equipped with a moving image capturing function.

CCD image sensors operate in such a manner that charge accumulated at light receiving elements is transferred to vertical transfer paths. After transferring charge in the vertical direction at the vertical transfer paths, charge is transferred in the horizontal direction at horizontal transfer paths so as to be outputted. One drawback of CCD image sensors is that “smears” occur as the result of saturation of charge within the vertical transfer paths. This is to say that line shaped high intensity portions appear in the vertical direction of the display screen as a result of charge overflowing within the vertical transfer paths.

It is typical for vertical transfer paths formed at CCD image sensors to exhibit photoelectric effects. Charge is accumulated when the vertical transfer paths are exposed to light. The vertical transfer paths therefore block out light as a result. Complete blocking of light at the vertical transfer paths is, however, difficult. This is because unnecessary charge due to exposure of the vertical transfer paths becomes accumulated within the vertical transfer paths.

Charge from the light receiving elements therefore becomes superimposed at the vertical transfer paths where unnecessary charge has been accumulated. There are therefore cases where charge generated as a result of exposure of the vertical transfer paths causes smearing.

### SUMMARY OF THE INVENTION

In order to resolve the situation described above, it is an object of the present invention to provide an image capturing device, a method of reducing smearing and a computer-readable storage medium that are capable of effectively reducing smearing.

In order to achieve the above object in a first aspect of the present invention, an image capturing device employing an image sensor including a light receiving element and a transfer path for transferring charge obtained by exposing the light receiving element to light, comprises: a control unit for causing the image sensor to output an image signal, the image signal including charge accumulated at the transfer path as a result of the photoelectric effect of the transfer path and not including charge accumulated at the light receiving element of the image sensor; and an output unit that subtracts the image signal outputted by the image sensor from an image signal including charge accumulated at the light receiving element of the image sensor and charge accumulated at the transfer path as the result of the photoelectric effect of the transfer path and outputs a moving image using an image signal for after subtraction.

A method of reducing smearing of a second aspect of the present invention is a method of reducing smearing at an image capturing device employing an image sensor including a light receiving element and a transfer path for transferring charge obtained by exposing the light receiving element to light comprises: a first reading step of reading an image signal including charge accumulated at the light receiving element of the image sensor and charge accumulated at the transfer path as the result of the photoelectric effect of the transfer path from the image sensor; a second reading step of reading an image signal that includes charge accumulated at the transfer path as the result of the photoelectric effect of the transfer path and does not include charge accumulated at the light receiving element from the image sensor; a subtraction step of subtracting the image signal read out in the second reading step from the image signal read out in the first reading step; and an output step of outputting a moving image using the image signal for after subtraction in the subtraction step.

In a third aspect of the present invention, a computer-readable storage medium that stores a program for implementing, on a computer for controlling an image capturing device employing an image sensor including a light receiving element and a transfer path for transferring charge obtained by exposing the light receiving element to light: a function for reading an image signal including charge accumulated at the light receiving element of the image sensor and charge accumulated at the transfer path as the result of the photoelectric effect of the transfer path from the image sensor; a function for reading an image signal that includes charge accumulated at the transfer path as the result of the photoelectric effect of the transfer path and does not include charge accumulated at the light receiving element from the image sensor; a function for subtracting the image signal that does not include the charge accumulated at the light receiving element from the image signal that does include the charge accumulated at the light receiving element; and a function for outputting a moving image using the image signal after the subtraction.

### BRIEF DESCRIPTION OF THE DRAWINGS

These objects and other objects and advantages of the present invention will become more apparent upon reading of the following detailed description and the accompanying drawings, in which:

FIG. 1 is a block diagram showing a configuration for a digital camera of embodiments of the present invention;

FIG. 2 is a schematic view illustrating an image sensor shown in FIG. 1:

FIG. 3 is a function block diagram showing functions implemented by the control unit shown in FIG. 1;

FIG. 4 is a timing chart illustrating the operation of a first embodiment of the present invention:

FIG. 5 is a flowchart illustrating “smear reduction processing (1)” of the first embodiment of the present invention;

FIG. 6 is a timing chart illustrating the operation of a second embodiment of the present invention; and

FIG. 7 is a flowchart illustrating “smear reduction processing (2)” of the second embodiment of the present invention.

### DETAILED DESCRIPTION OF THE PREFERRED EMBODIMENTS

Embodiments of the present invention are now described with reference to the drawings. In the embodiments, an example is shown of a case the present invention implemented by a digital camera. A digital camera 1 of this embodiment is taken to have at least a moving image capturing function. In this event, in addition to being a digital camera that captures and records moving images such as a digital video camera, the digital camera 1 can also be a digital still camera that displays and outputs moving images as finder images.

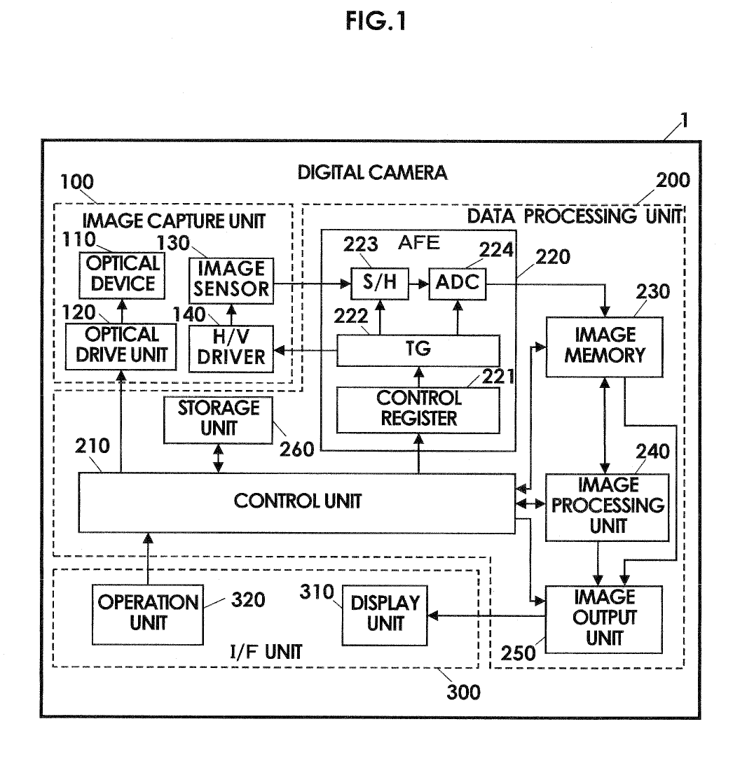

FIG. 1 is a block diagram showing a configuration for a digital camera 1 of the embodiments of the present invention. As shown in the drawings, an outline of a configuration for the digital camera 1 of this embodiment is an image capture unit 100, a data processing unit 200, and an interface (I/F) unit 300, etc.

The image capture unit 100 is the portion of the digital camera 1 that performs image sensing. As shown in the drawings, the image capture unit 100 is constructed from an optical device 110, an optical drive unit 120, an image sensor 130, and a horizontal/vertical driver (H/V driver) 140, etc.

The optical device 10 carries out optical operations involved in image capture such as, for example, for a lens and a focusing mechanism. The optical drive unit 120 is constructed, for example, from a motor, an actuator, and a drive circuit (driver), and performs drive control of the optical device 110 based on the control of a control unit 210. By the action of the optical device 110 subjected to the drive control of the optical drive unit 120, incident light is then focused and optical elements affecting the angle of view, focusing, and exposure etc. such as the focal length and the aperture can be adjusted. Incident light focused by the optical device 110 then forms an image on the image sensor 130.

The image sensor 130 is a solid-state image sensing element that generates an electrical signal indicating a subject image formed by the optical device 110. Light receiving elements (photodiodes etc) corresponding to the pixels carry out photoelectric conversion so as to generate charge corresponding to exposure, whereby the image sensor 130 generates an electrical signal indicating the subject image. In this embodiment, it is taken that an image sensor (for example, a charge coupled device (CCD) image sensor) is of a structure where charge generated by exposure of the light receiving elements is read out as an image signal by vertical transfer in line units.

The H/V driver 140 is a drive circuit that controls charge transfer at the image sensor 130. The H/V driver 140 then converts a pulse signal from a timing generator (TG) 222 described later to an electrical potential and drives the image sensor 130 by applying the electrical potential to the image sensor 130. Charge accumulated at each of the light receiving elements is then horizontally transferred after being vertically transferred by such a drive control and is outputted as an image signal.

The data processing unit 200 processes an electrical signal generated by an image sensing operation of the image capture unit 100, generates digital data indicating a captured image, and carries out image processing etc. on the captured image. As shown in FIG. 1, the data processing unit 200 includes the control unit 210, an analog front end (AFE) 220, an image memory 230, an image processing unit 240, an image output unit 250, and a storage unit 260, etc.

The control unit 210 is constructed from, for example, a processor such as a central processing unit (CPU) and a main storage device (memory) such as RAM (Random Access Memory) etc., and controls each part of the digital camera 1 by executing programs stored in the storage unit 260 etc. described later. In this embodiment, the control unit 210 implements functions for each of the processes described in the following by executing a prescribed program.

The AFE 220 carries out an operation of converting an analog image signal outputted by the image sensor 130 to digital image data and an operation of controlling the H/V driver 140 based on the instructions from the control unit 210, which will be described later. As shown in FIG. 1, the AFE 220 is constructed from a control register 221, the timing generator (TG: Timing Generator) 222, a sample/hold circuit (S/H) 223, and an A-D converter (analog-digital converter: ADC) 224, etc.

The control register 221 receives control commands from the control unit 210 and controls the TG222 and the ADC224 according to the commands.

The TG222 then generates a pulse signal for causing the image sensor 130 to operate and applies the pulse signal to the H/V driver 140 under the control of the control register 221. In this event, the TG222 generates pulse signals such as a vertical sync signal VD indicating the vertical transfer timing of the image sensor 130, a horizontal sync signal HD indicating horizontal transfer timing for a vertically transferred charge, a charge read out signal SG indicating a timing of reading out of a charge, a charge discharge signal SUB indicating timing of discharging residual charge, and a reset signal RST for resetting charge accumulated at the light receiving element and applies the signals to the H/V driver 140. An image signal output operation due to the image sensor 130 and a digital conversion operation for the outputted image signal are synchronized as a result of the vertical sync signal VD and the horizontal sync signal HD etc. being applied to the S/H 223 and ADC 224 within tie AFE 220.

The S/H 223 is a sample/hold circuit that samples and holds one pixel portions of an analog image signal outputted by the image sensor 130 for input to the ADC 224 of the following stage.

The ADC224 is, for example, an analog/digital converter (ADC) mounted with a CDS circuit (CDS: Correlated Double Sampling) and an analog amplifier etc. that converts analog image signals outputted by the image sensor 130 to digital image data. In this event, after amplifier noise and reset noise included in the analogue image signal from the image sensor 130 is removed by the CDS circuit, amplifying is carried out according to imaging sensitivity by an analog amplifier and conversion to digital data takes place at the ADC.

The image memory 230 is constructed from a semiconductor storage device such as RAM or flash memory etc. and stores digital image data converted by the ADC 224.

The image processing unit 240 is constructed from a processor for image processing use (a so-called image processing engine) or the like and carries out various image processing on digital image data stored at the image memory 230.

This is where adjustment such as white balance and picture quality adjustment and data compression etc. is carried out.

The image output unit 250 is constructed from, for example, an RGB signal (video signal) generating circuit etc. The image output unit 250 carries out display output of the captured image by converting digital image data that is stored at the image memory 230 and has been image processed to an RGB signal for output to a display unit 310 or an external output terminal etc.

The storage unit 260 is constructed, for example, from a storage device such as a ROM (read only memory) or flash memory and stores programs and data etc. necessary for the operation of the digital camera 1. In this embodiment, it is taken that operating programs executed by the control unit 210 etc. and parameters and arithmetic expressions etc. required in the processing are stored in the storage unit 260. For example, the storage unit 260 is taken to also include external storage media such as memory cards and stores captured image data etc.

The I/F unit 300 constitutes an interface between the digital camera 1 and the user or an external device. As shown in FIG. 1, the I/F unit 300 comprises the display unit 310 and an operation unit 320 etc.

The display unit 310 comprises, for example, a liquid crystal display device etc. The display unit 310 displays various screens necessary for operating the digital camera 1, live view images (finder images) when photographing, and captured images etc. for output. In this embodiment, displaying and output of captured images etc. is carried out based on the image signals (RGB signals) from the image output unit 250.

The operation unit 320 is configured from buttons, etc. constructed on the outer surface of the digital camera 1. The operation unit 320 generates an input signal corresponding to operation by a user of the digital camera 1 for input to the control unit 210. For example, a shutter button for instructing starting and stopping of photographing operations (when taking moving images) or for instructing a shutter operation (when taking still images) a mode button instructing various operating modes that the digital camera 1 has, and numeric keys and function buttons for the various settings can be included as buttons constituting the operation unit 320.

It is taken that the digital camera 1 of this embodiment is provided with the basic functions of a digital camera (digital video camera, digital still camera) and structures that can be used for various additional functions as necessary.

The digital camera I of this embodiment is a digital camera having a moving image photographing function adopting a CCD image sensor as the image sensor 130. In the case of this kind of structure, there are cases where smearing occurs when taking moving images. It is therefore the object of the present invention to reduce this kind of smearing. The theory, etc. for where smearing occurs in the digital camera 1 of the above configuration is described in the following.

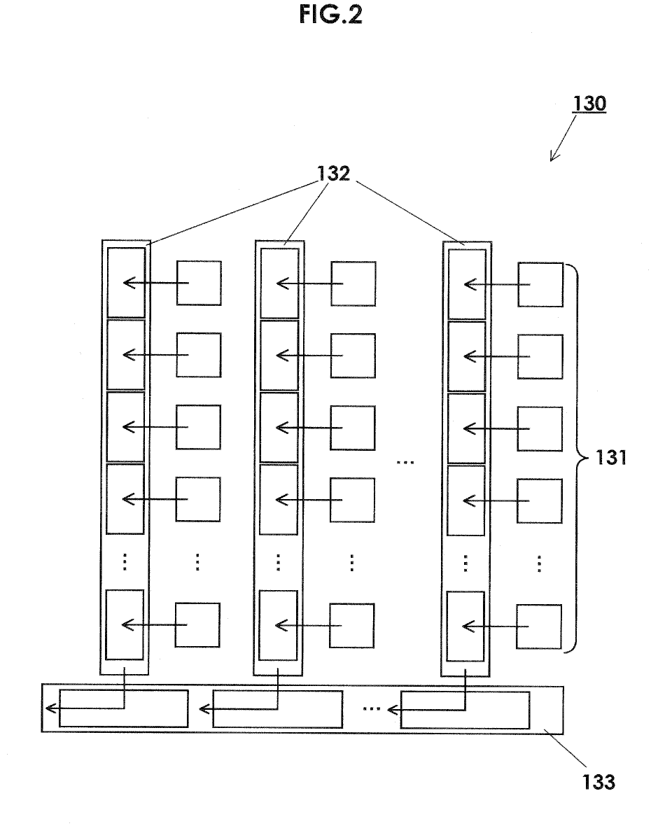

A description is given of an image sensor capable of reducing smearing by adopting the present invention. In this embodiment, for example, as shown in FIG. 2, it is taken that an inter-line transfer type CCD (IT-CCD) image sensor can be used as the image sensor 130. The image sensor 130 in this event, as shown in the drawings, comprises light receiving elements 131 such as photodiodes arranged in a matrix, a vertical transfer CCD 132 that transfers charge accumulated at each of the light receiving elements 131 in a vertical direction, and a horizontal transfer CCD 133 that transfers charge transferred by the vertical transfer CCD 132 in a horizontal direction for output to the latter stage AFE 220. The vertical transfer CCD 132 reads out charge accumulated at each of the light receiving elements 131. The horizontal transfer CCD 133 reads out charge accumulated within the vertical transfer CCD 132.

With a CCD of this configuration a period of time that charge is accumulated by the light receiving elements (so-called exposure period) can be controlled by controlling the timing of the transfer of charge from the light receiving elements to the vertical transfer CCD (a so-called “electronic shutter”). When photographing moving images, image signals can be read out in frame units by transferring charge accumulated at the light receiving elements in a portion of time for one frame to the vertical transfer CCD according to the set frame rate.

When a strong light source (for example, the sun etc.) is captured within the photographing angular field of view at a CCD that outputs an image signal using this kind of operation, at the light receiving element that receives light from this light source, charge becomes saturated even for an appropriate exposure period. Saturated charge therefore overflows to the vertical transfer CCD and charge within the vertical transfer CCD successively overflows. As a result, smearing occurs in the form of line-shaped high-intensity portions in the vertical direction on the displayed moving image. This is the theory for the typical appearance of smearing which occurs particularly easily when photographing moving images where it is not possible to block out light using a mechanical shutter.

Saturation of charge at the light receiving elements is therefore the main cause of the appearance of smearing but there are also cases where exposure of the vertical transfer CCD causes smearing. The light receiving elements and the vertical transfer CCD are formed on the light receiving surface of the image sensor 130. Because the vertical transfer CCD is covered with a light-blocking film (for example, an aluminium thin-film etc.) provided at the side of the exposed surface of the vertical transfer CCD, light to the vertical transfer CCD is blocked out by the light-blocking film. It is, however, difficult to block out light completely. The vertical transfer CCD therefore becomes exposed, for example, as a result of light infiltrating into the vertical transfer CCD from a light receiving element side nearby or as the result of light passing through the light-blocking film.

In this event, charge also occurs within the vertical transfer CCD prior to the transfer of charge from the light receiving element. The respective charges therefore become superimposed when the transfer of charge from the light receiving elements so as to cause smearing. Smearing therefore occurs even when charge is not saturated at the light receiving element.

Regarding charge occurring within the vertical transfer CCD after outputting of the charge as the image signal, residual charge is swept up by applying a charge discharge signal SUB to the image sensor 130. This kind of technique is, e.g., disclosed in Unexamined Japanese Patent Application KOKAI Publication No. 2005-123795 A. It is therefore possible to prevent residual charge being superimposed with charge for the next image (frame).

However, the vertical transfer CCD is also exposed during the period of exposure of the light receiving elements. Charge generated at the vertical transfer CCD at this time is therefore superimposed with charge transferred from the light receiving elements and is outputted as an image signal. This is to say that even if the residual charge is swept out after output of an image signal, charge generated within the vertical transfer CCD during the exposure period is not removed. It is therefore not possible to eliminate smearing simply by sweeping out residual charge in the conventional manner when charge is the cause of smearing in this way.

In the following, application of the present invention is exemplified by a method of reducing smearing caused by exposure of a vertical transfer CCD during the exposure period.

### First Embodiment

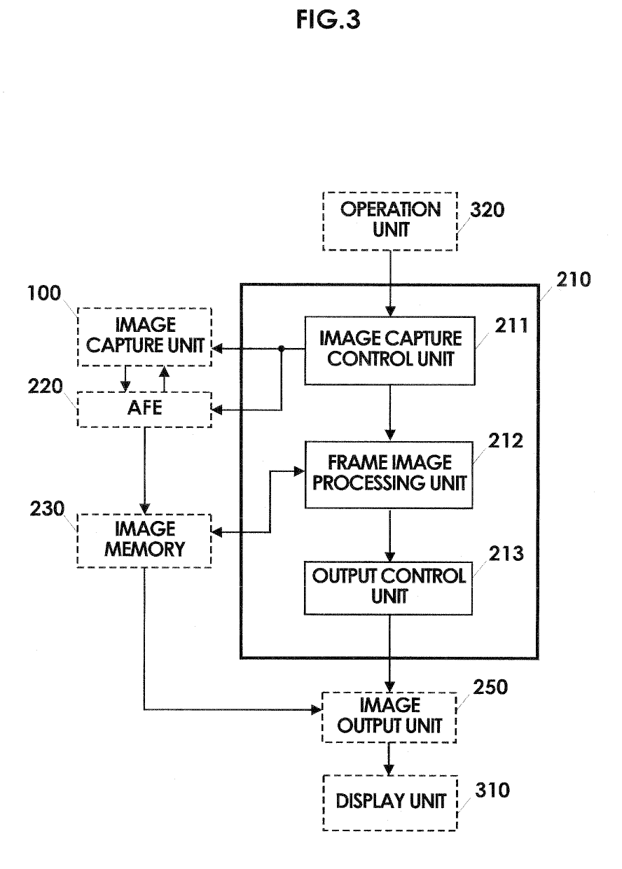

In this embodiment, driving of the image sensor 130 is controlled in order to reduce smearing occurring when taking moving images using the digital camera 1 of the above structure, and calculations are carried out using generated frame images (digital image data). The function for implementing the above operation can be implemented as a result of the control unit 210 executing a program. A function configuration implemented by the control unit 210 is shown in FIG. 3. FIG. 3 is a function block diagram showing functions implemented by the control unit 210. As shown in the drawing, the control unit 210 functions as an image capture control unit 211, a frame image processing unit 212, and an output control unit 213 etc.

In addition to inputting control signals according to set photographing parameters etc. to the optical drive unit 120 so as to control the operation of the optical device 110, the image capture control unit 211 generates control commands for controlling driving of the image sensor 130 and sends the control commands to the control register 221 of the AFE 220. Image signals are read out from the image sensor 130 in frame image units constituting moving images when capturing moving images. However, in this embodiment, the transfer of charge accumulated at the light receiving elements 131 to the vertical transfer CCD 132 does not occur for the next frame to the frame for which normal image signal read out was carried out. Charge is instead only transferred from the vertical transfer CCD 132 to the horizontal transfer CCD 133.

In the image signal for the frame read out normally, charge accumulated as a result of the light receiving elements 131 being exposed and charge accumulated within the vertical transfer CCD 132 as the result of the vertical transfer CCD 132 itself being exposed becomes superimposed. In this event, reflection of the subject image is constituted by the charge accumulated by the light receiving elements 131. Charge accumulated within the vertical transfer CCD 132 is therefore surplus charge that will cause smearing. This means that an image signal obtained by normal reading will contain “an image component+a smear component”.

In control for carrying out this normal read out operation, at the end timing for the exposure period, charge indicating the subject image is transferred to the vertical transfer CCD 132 by applying the charge read out signal SG for transferring charge accumulated at the light receiving elements 131 to the vertical transfer CCD 132 to the image sensor 130. Also, by applying the vertical sync signal VD and the horizontal sync signal HD, charge transferred to the vertical transfer CCD 132 is then transferred to the horizontal transfer CCD 133 and outputted from the image sensor 130. Charge remaining at the vertical transfer CCD 132 during the transfer period and charge accumulated in the vertical transfer CCD 132 after the transfer period is then swept out by applying a charge discharge signal SUB to the image sensor 130. A reset signal RST for resetting charge accumulated at the light receiving elements 131 is then applied to the image sensor 130 when the exposure period ends.

The image capture control unit 211 generates a control command so that the image sensor 130 is driven in this way and inputs the control command to the control register 221, whereby a pulse signal in accordance with the control command is applied to the image sensor 130.

Frames obtained by normal reading out are constituted by images including an image component and a smear component. It is therefore possible to obtain frames for only the image component if an image for only the smear component is subtracted from the frame image. Driving of the image sensor 130 is therefore controlled so as to give a frame image for only the smear component at the next frame in order to carry out this kind of subtraction.

The smear component in this case is charge generated as a result of exposure of the vertical transfer CCD 132 during the exposure period for the light receiving elements 131. In the next frame only charge accumulated within the vertical transfer CCD 132 is outputted as the image signal by taking the same exposure period as for the exposure period from the previous frame so as to obtain an image signal indicating an image for only the smear component. In this case, the charge read out signal SG for transferring the charge accumulated at the light receiving elements 131 to the vertical transfer CCD 132 is not applied to the image sensor 130. By applying the vertical sync signal VD and the horizontal sync signal HD, charge accumulated at the vertical transfer CCD 132 is therefore transferred to the horizontal transfer CCD 133 and outputted from the image sensor 130. Charge remaining at the vertical transfer CCD 132 during the transfer period and charge accumulated in the vertical transfer CCD 132 after the transfer period is then swept out by applying a charge discharge signal SUB to the image sensor 130. A reset signal RST for resetting charge accumulated at the light receiving elements 131 is then applied to the image sensor 130 when the exposure period ends. As a result, only charge generated as the result of exposure of the vertical transfer CCD 132 for just the same time as the exposure period for the previous frame is outputted as the image signal.

The image capture control unit 211 then generates a control command so that the image sensor 130 is driven in this way and inputs the control command to the control register 221, whereby a pulse signal in accordance with the control command is applied to the image sensor 130.

An image signal indicating a frame for only the smearing component can then be outputted. If this frame is deleted from the previous frame, it is possible to obtain a frame for only the image component. The image sensor 130 is therefore controlled so as to be driven to alternately obtain a normally read out frame and a frame for only smearing. As an example of this kind of operation, in this embodiment, it is taken at odd-numbered frames are read out normally and even-numbered frames are read out only for the smearing component.

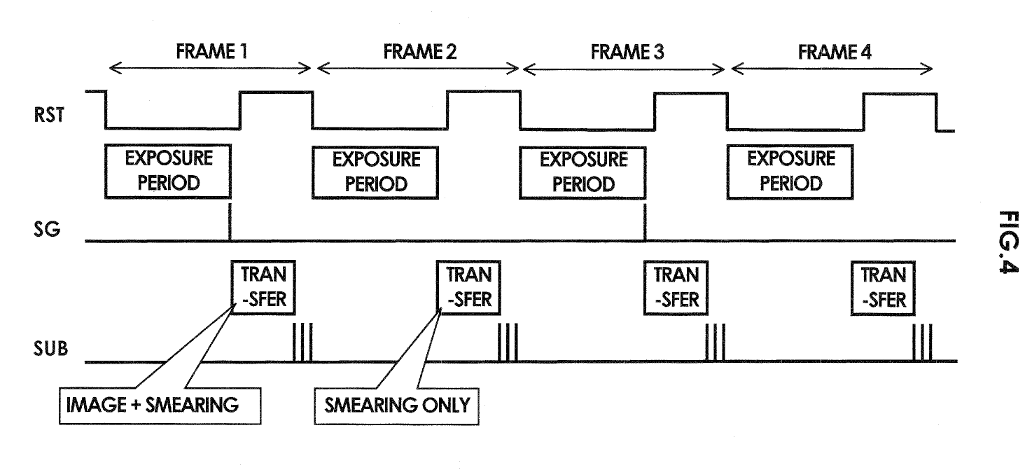

As shown in the timing chart FIG. 4, at the time of odd-numbered frames, charge accumulated at the light receiving elements 131 is transferred to the vertical transfer CCD 132 by applying the charge read out signal SG at the timing of ending of the exposure period. Also, by applying the vertical sync signal VD and the horizontal sync signal HD, the vertically transferred charge is transferred to the horizontal transfer CCD 133, and the charge transferred to the horizontal transfer CCD 133 is outputted from the image sensor 130. Charge remaining in the vertical transfer CCD 132 during the transfer period and charge accumulated within the vertical transfer CCD 132 as the result of exposure after the transfer period are then swept up by applying the charge discharge signal SUB together with the end of transfer of the charge.

On the other hand, with even-numbered frames, the charge read out signal SG is not applied at the timing of ending of the exposure period (see FIG. 4), but by applying the vertical sync signal VD and the horizontal sync signal HD rather just charge accumulated as the result of the vertical transfer CCD 132 being exposed during the exposure period is transferred and outputted from the image sensor 130. This gives “T1=T2” when the exposure period for an odd-numbered frames is taken to be T1 and the exposure period for even-numbered frames is taken to be T2.

The image signal read out as the result of drive control of the image sensor is converted to digital image data by the ADC 224 of the AFE 220 and is sequentially stored at the image memory 230 as frame image data.

The frame image processing unit 212 removes smearing from photographed moving images by carrying out processing using frame image data stored at the image memory 230. Odd-numbered frames including image components and smearing components and even-numbered frames for only smearing components can then be stored at the image memory 230 by controlling driving of the image sensor 130 using the image capture control unit 211. Frame images for only the image components are then generated by carrying out processing to subtract image data for the next even-numbered frame from an image data for the odd-numbered frame in order of frame number. In this event, for example, processing is carried out to subtract pixel values at the same coordinates across both frame images. It is also possible to reduce the amount of processing by subtracting in block units.

The frame image processing unit 212 stores frame images generated for only image components in this manner sequentially at the image memory 230. Namely, image data composed only from the image data that does not include smearing components is generated. In this event, it is possible to sequentially delete frame data stored initially at the image memory 230 after the frame data is used in the subtraction processing.

The output control unit 213 instructs the image output unit 250 to output moving image data from which the smearing component has been removed by the frame image processing unit 212. In this case, the output control unit 213 notifies the image output unit 250 of information (for example, data name appended at the time of creation or an address within the image memory 230 indicating a storage location etc.) specifying moving image data with a smearing component removed. As a result, the image output unit 250 sequentially acquires moving image data with the smearing component removed from the image memory 230, converts the moving image data to a video signal such as an RCB signal, and outputs the video signal to the display unit 310.

The functions above are functions implemented by the control unit 210. In this embodiment it is taken that to each of the functions are implemented using logic processing where the control unit 210 executes programs. However, it is also possible for these functions to be configured using hardware, such as an ASIC (Application Specific Integrated Circuit). Of the functions shown in FIG. 3, it is preferable for the function involved in the image processing (a frame image processing unit 212 etc.) to be implemented by the image processing unit 240 under the control of the control unit 210. It is also possible for the control unit 210 and the image processing unit 240 to be implemented as individual configurations or to be implemented in an integral manner using a single semiconductor chip. Similarly, the data processing unit 200 including the control unit 210 and the image processing unit 240 can be implemented using separate structures or can be implemented using a single structure.

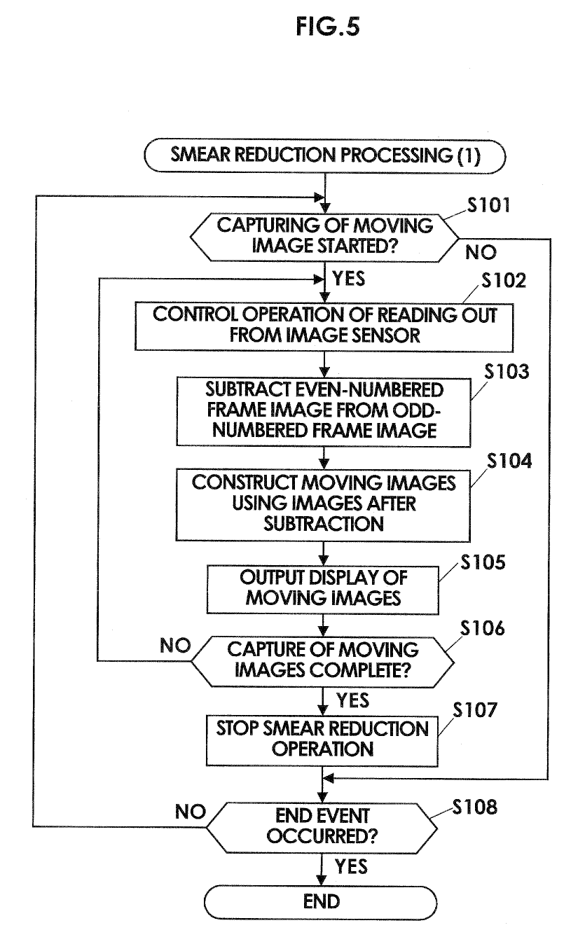

The operation of the digital camera 1 of the above configuration is described in the following. Here, “smear reduction processing (1)” executed by the control unit 210 at the time of photographing by the digital camera 1 is described with reference to the flowchart of FIG. 5. This “smear reduction processing (1)” starts, for example, when the power supply is put on at the digital camera 1.

When the power supply is put on the digital camera 1, the user of the digital camera 1 instructs selection or operation of the desired mode by operating the operation unit 320. In this event, an input signal generated by the operation unit 320 is inputted into the control unit 210. When timing of the starting of moving image photographing is determined based on an input signal from the operation unit 320 (step S101: yes), the image capture control unit 211 controls the operation of reading out from the image sensor 130 by sending a control command for reducing smearing when photographing moving images to the control register 221 (step S102).

As described above, the image sensor 130 is controlled to carry out a normal read out operation for odd-numbered frames and a read out operation only for the smear component for even-numbered frames.

Frame image data read out as a result of the control is then stored sequentially at the image memory 230. The frame image processing unit 212 then subtracts image data for the next even-numbered frame constituted only of a smear component from the image data for the odd-numbered frame constituted from the image component and the smear component (step S103). A moving image sequence is then constituted using images after subtraction, i.e. “image component+smear component” images with the smear components subtracted and is stored at the image memory 230 (step S104).

The frame image processing unit 212 then outputs moving images without smears to the display unit 310 for display thereon by sending moving image data with the generated smear component removed as described above to the image output unit 250 (step S105).

When the timing of ending of the photographing of the moving image is determined based on an input signal etc. from the operation unit 320 (step S106: Yes), the image capture control unit 211 and the frame image processing unit 212 stop the operation of reducing the smearing described above (step S107). Namely, the image capture control unit 211 sends a control command for giving a normal read out operation to the control register 221 and the frame image processing unit 212 does not carry out subtraction processing etc. between the frames.

As a result of the above operation, an operation can be carried out in order to reduce smearing when photographing moving images in a manner where the occurrence of smearing is striking. This is to say that up to when photographing of a moving image ends (step S106: No), a moving image with the smear component removed can be displayed at the display unit 310 by repeating the operation of step S102 to step S105.

This process ends as the result of the occurrence of an end event such as the turning off of the power supply of the digital camera 1 (step S108: Yes). However, if moving image photographing starts again before the appearance of the end event (step S108: No, step S101; Yes), the processing described above is carried out on each occasion and the occurrence of smears in the display moving image is reduced.

In the above, according to this embodiment, it is possible to remove smears caused by charge occurring as the result of the exposure of the vertical transfer CCD 132.

### Second Embodiment

It is possible to reduce the smearing of moving images using the message shown in the first embodiment. However the number of frames for the moving images displayed for output is smaller than the number of frame images that are actually taken. This is an inconvenience when it is wished to make the frame rate high.

A method for alleviating this inconvenience is exemplified in this embodiment. In this embodiment it is possible to reduce the influence on the frame rate by making the exposure period shorter for frames for only the smear component. As with the first embodiment, it is taken that odd-numbered frames include an image component and a smear component and that even-numbered frames have only a smear component.

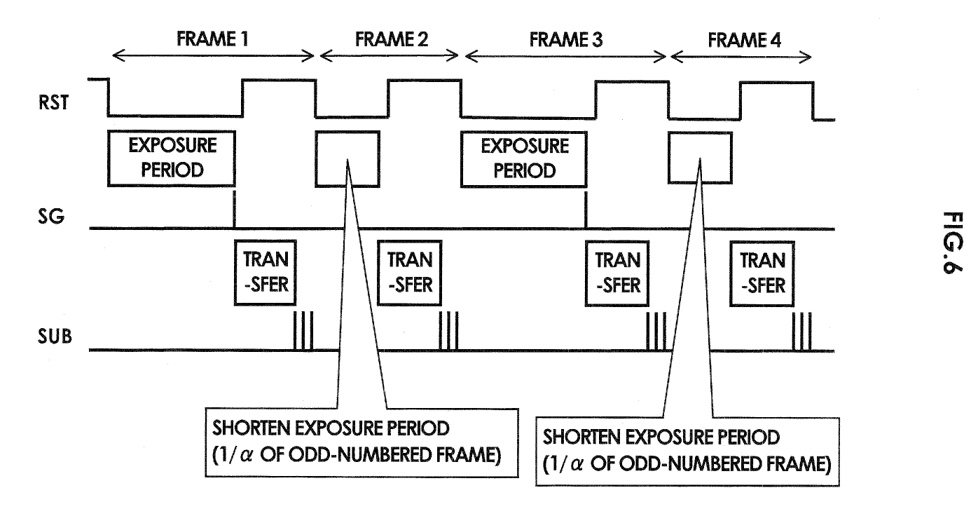

An outline of the operation of this embodiment is described with reference to the timing chart shown in FIG. 6. As shown in the drawings, a cycle for reading out charges is the same as the case for the first embodiment but the exposure period for the even-numbered frames is made shorter than the exposure period for the odd-numbered frames. Here, a period of time that is 1/α of the exposure period for the odd-numbered frames is taken as the exposure period for the even-numbered frames. This is to say that the relationship between an exposure period T1 for the odd-numbered frames and an exposure period T2 for the even-numbered frames becomes T1>T2(T2=T1/α).

The amount of charge generated as the result of the exposure of elements exhibiting the photoelectric effect (light receiving elements 131 and the vertical transfer CCD 132) is substantially proportional to the exposure period. If the amount of charge for even-numbered frames obtained using the exposure period T2(=T1/α) is taken to be a times, then this becomes substantially the same as the amount of charge generated when the vertical transfer CCD 132 is exposed at the exposure period T1. Namely it is possible to correct the amount of charge even if the exposure period changes by using a fixed coefficient in the relationship between the exposure period and the amount of charge In this event a coefficient (1/α) for shortening the exposure period and a coefficient (α) for correcting the amount of charge are taken to have a mutually reciprocal relationship.

If the same subtractions as in the first embodiment are then carried out using frame image data obtained by correcting the amount of charge it is possible to reduce smears even if the exposure period for the even-numbered frames is made short.

It is therefore possible to reduce the influence on the frame rate by making the exposure period shorter for even-numbered frames that do not include an image component constituting a display output target and sufficient smear reduction effects can therefore be obtained.

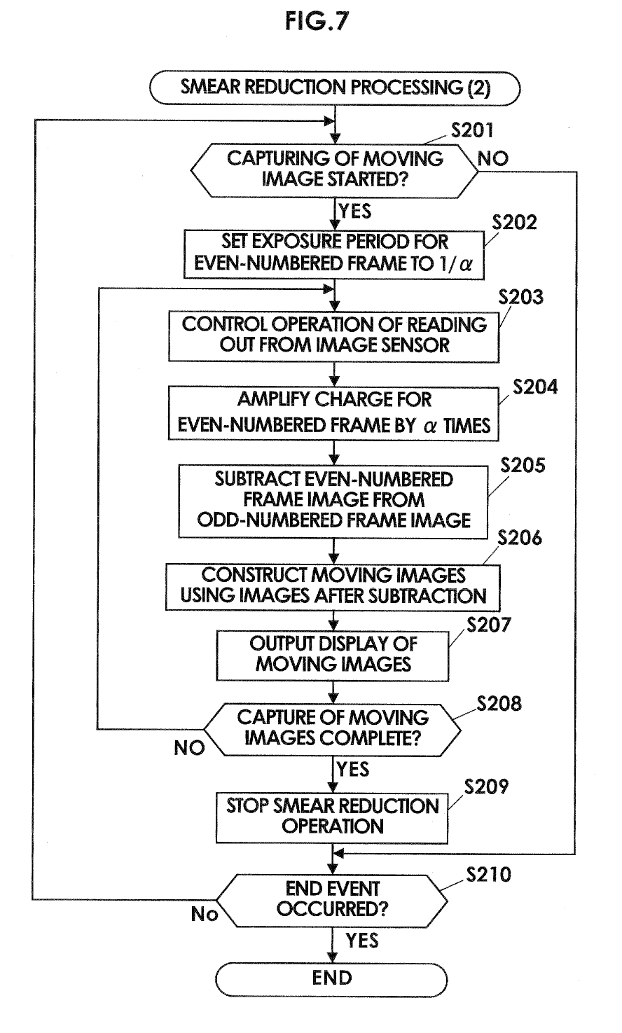

“Smear reduction processing (2)” executed by the control unit 210 in this case is described with reference to the flowchart of FIG. 7. The start conditions etc. for this “smear reduction processing (2)” are the same as for the “smear reduction processing (1)” shown in the first embodiment.

When a moving image photographing start time is reached at the digital camera 1 (step S201: yes), the image capture control unit 211 sets the exposure period for the even-numbered frames to 1/α of the normal exposure period (step S202). The exposure period (T1) for the odd-numbered frames is taken to be the normal exposure period. The exposure period (T2) for the even-numbered frames is then 1/α of the exposure period for the odd-numbered frames.

The image capture control unit 211 then controls the operation of reading out from the image sensor 130 by sending a control command for reducing the smear when photographing moving images at the set exposure period to the control register 221 (step S203). Namely, the image capture control unit 211 sends a control 1 command that puts a timing for discharging charge accumulated at the vertical transfer CCD 132 as a result of exposure at the even-numbered frames to 1/α of the normal exposure period to the control register 221.

In this case, the image capture control unit 211 amplifies charge outputted from the image sensor 130 as an image signal for the even-numbered frame by α times by sending a control command that controls an amplifying operation of an analog amplifier of the ADC 224 to the control register 221 (step S204). The operation of the ADC 224 is synchronized with the frames based on the vertical sync signal VD and the horizontal sync signal HD. It is therefore possible to control the analog amplifier of the ADC 224 so as to only increase the image signal for the even-numbered frames a times.

As a result of this operation, frame image data for odd-numbered frames based on charge generated during a normal exposure period and frame image data for even-numbered frames where the exposure period is 1/α of the normal exposure period and a charge is corrected into one that is generated during the normal exposure period is stored sequentially at the image memory 230. This means that as in the first embodiment the frame image processing unit 212 subtracts image data for the next even-numbered frame constructed from only a smear component from the image data for the odd-numbered frame constructed from an image component and a smear component (step S205). A moving image sequence is then constructed using images for after subtraction and is stored at the image memory 230 (step S206).

From here onwards, the appearance of smears in the moving image displayed when photographing a moving image is reduced by carrying out the same processing as for the “smear reduction processing (1)” (FIG. 5) of the first embodiment (step S207 to step S210).

According to this embodiment, it is possible to remove smears caused by a charge generated as a result of exposure of the vertical transfer CCD 132 and it is possible to improve the frame rate.

As described above, it is possible to effectively reduce smears occurring when photographing moving images by application of the present invention to the embodiments described above.

This is to say that it is possible to subtract image data for only surplus charge (charge generated as a result of exposure of a vertical transfer CCD) from image data that latently includes surplus charge by performing control so as to read out only the surplus charge for a subsequent frame to a frame subjected to normal reading out while reading out an image signal in frame units from an image sensor having vertical transfer paths (vertical transfer CCD) constructed from CCDs that exhibits the photoelectric effect. It is therefore possible to obtain image data based only on charge indicating a subject image generated as a result of light being received by light receiving elements. This makes it possible to reduce the occurrence of smearing caused by surplus charge.

In this case, it is possible to obtain image signals for only surplus charge that is the cause of smearing by controlling the transfer of charge accumulated at the light receiving elements of the image sensor to vertical transfer paths in frame units. This is to say that it is possible to reduce smearing by simply controlling the timing of application of the charge read out signal SG without having to add modifications to the hardware of a digital camera.

It is therefore possible to make the exposure period short for frames for surplus charge only by carrying out arithmetic processing using coefficients. It is therefore possible to reduce smearing and increase the frame rate.

The above embodiments are given as an example and by no means restrict the range of application of the present invention. Namely, various applications are possible and every and all practical examples are included in the scope of the present invention.

For example, in the above embodiments, an inter-line transfer type CCD (IT-CCD) image sensor is exemplified as a CCD image sensor that can be used as the image sensor 130 but it is possible to reduce the smear through the application of the present invention with any image sensor (for example, a frame transfer type CCD (FT-CCD) image sensor etc.) equipped with vertical transfer paths that exhibit the photoelectric effect.

When the present invention is implemented in an image capturing device such as the digital camera 1 exemplified by the above embodiments, in addition to providing an image capturing device equipped with this structure and function of the present invention, it is also possible for an existing image capturing device to function as the image capturing device of the present invention by application of a program implementing the same functions as each of the functions of the control unit 210.

In the above embodiments, a digital still camera having a moving image capturing function is shown as an example of an image capturing device but the form of the image capturing device is arbitrary and can also be implemented using a single digital video camera or digital still camera so as to enable the present invention to be applied to various electronic equipment (for example, mobile telephones etc.) equipped with the same image capturing function as this.

It is also possible to make an existing device function as an image capturing device in the present invention through application of a program in this case also.

The method of applying this program is arbitrary and in addition to application through storage on a storage medium such as, for example, a CD-ROM or a memory card, application via a communication medium such as, for example, the Internet is also possible.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

What is claimed is:

1. An image capturing device employing an image sensor including a light receiving element and a transfer path for transferring charge obtained by exposing the light receiving element to light, comprising:
a control unit for causing the image sensor to output an image signal, the image signal including charge accumulated at the transfer path as a result of the photoelectric effect of the transfer path and not including charge accumulated at the light receiving element of the image sensor; and
an output unit that subtracts the image signal outputted by the image sensor from an image signal including charge accumulated at the light receiving element of the image sensor and charge accumulated at the transfer path as the result of the photoelectric effect of the transfer path, and outputs a moving image using an image signal for after subtraction.

2. The image capturing device according to claim 1, wherein the control unit causes the image sensor to output the image signal that does not include the charge accumulated at the light receiving element by controlling operation of transferring the charge accumulated at the light receiving element to the transfer path.

3. The image capturing device according to claim 2, wherein the control unit does not allow transfer of the charge accumulated at the light receiving element to the transfer path for a subsequent frame to a frame where the charge accumulated at the light receiving element of the image sensor is transferred to the transfer path.

4. The image capturing device according to claim 2, further comprising an exposure period control unit that shortens exposure period for a frame where the control unit does not allow transfer of the charge accumulated at the light receiving element to the transfer path to be a second exposure period that is a coefficient multiple of a first exposure period for a frame immediately preceding the current frame,
wherein the output unit subtracts an image signal, which is obtained by multiplying an image signal for the frame taken using the second exposure period by an inverse of the coefficient, from an image signal for the immediately preceding frame.

5. A method of reducing smearing at an image capturing device employing an image sensor including a light receiving element and a transfer path for transferring charge obtained by exposing the light receiving element to light comprising:
a first reading step of reading an image signal including charge accumulated at the light receiving element of the image sensor and charge accumulated at the transfer path as the result of the photoelectric effect of the transfer path from the image sensor;
a second reading step of reading an image signal that includes charge accumulated at the transfer path as the result of the photoelectric effect of the transfer path and does not include charge accumulated at the light receiving element from the image sensor;
a subtracting step of subtracting the image signal read out in the second reading step from the image signal read out in the first reading step; and
an output step of outputting a moving image using the image signal for after subtraction in the subtracting step.

6. The method of reducing smearing according to claim 5, further comprising:
an exposure period control step of shortening exposure period for generating the image signal read out in the second reading step to be a second exposure period that is a coefficient multiple of a first exposure period for generating the image signal read out in the first reading step; and
a signal amplifying step of amplifying the image signal read out in the second reading step by multiplying the image signal by an inverse of the coefficient,
wherein, in the subtracting step, the image signal amplified in the signal amplifying step is subtracted from the image signal read out in the first reading step.

7. A computer-readable storage medium that stores a program for implementing, on a computer for controlling an image capturing device employing an image sensor including a light receiving element and a transfer path for transferring charge obtained by exposing the light receiving element to light;
a function for reading an image signal including charge accumulated at the light receiving element of the image sensor and charge accumulated at the transfer path as the result of the photoelectric effect of the transfer path from the image sensor;
a function for reading an image signal that includes charge accumulated at the transfer path as the result of the photoelectric effect of the transfer path and does not include charge accumulated at the light receiving element from the image sensor;
a function for subtracting the image signal that does not include the charge accumulated at the light receiving element from the image signal that does include the charge accumulated at the light receiving element; and
a function for outputting a moving image using the image signal after the subtraction.

8. The computer readable storage medium according to claim 7, further storing programs for implementing, on a computer:
a function for shortening an exposure period for generating the image signal that does not include the charge accumulated at the light receiving element to be a second exposure period that is a coefficient multiple of a first exposure period for generating the image signal including the charge accumulated at the light receiving element; and
a function for amplifying the image signal that does not include the charge accumulated at the light receiving element by multiplying the image signal by an inverse of the coefficient.
